(19) United States
(12) Patent Application Publication
(10) Pub. No.: US 2007/0039115 A1
(43) Pub. Date: Feb. 22, 2007

(54) Surface wiper

(75) Inventor: Barrie Stefel, Philadelphia, PA (US)

Correspondence Address: MORGAN, LEWIS & BOCKIUS LLP, 1701 MARKET STREET, PHILADELPHIA, PA, 19103-2921, US

(73) Assignee: LN International, Inc.

(21) Appl. No.: 11/204,721

(22) Filed: Aug. 16, 2005

(51) Int. Cl. G02C 13/00

(52) U.S. Cl. 15/214; 15/210.1

(57) ABSTRACT

A surface wiper having a swivel and swivel lock.

### SUMMARY OF THE INVENTION

In one embodiment, the present invention provides an eyeglasses wiper.

In one embodiment, the present invention includes an eyeglass wiper having a pair of tongs, wherein each tong includes a head on a free end and wherein the tongs are connected by a swivel. A tong also includes a wiping component that is connected to the head of a tong. The present invention also includes a swivel lock that prevents free rotation of the tongs about the swivel when the swivel lock is engaged.

### BRIEF DESCRIPTION OF THE DRAWINGS

The present invention may be better understood by reference to the description which follows taken together with the accompanying figures which illustrate the present invention wherein:

FIG. 1 shows a perspective view of an embodiment of a surface wiper according to the present invention;

FIG. 2 shows a perspective view of an embodiment of a surface wiper according to the present invention wherein the wiping components are separated by 180 degrees;

FIG. 3 shows an exploded perspective view of a surface wiper according to the present invention;

FIG. 4 shows another exploded perspective view of a surface wiper according to the present invention;

FIG. 5 shows the layering structure of a wiping component according to the present invention;

FIG. 6 shows wiping surface components according to the present invention; and

FIG. 7 shows wiping surface components according to the present invention.

### DETAILED DESCRIPTION OF PREFERRED EMBODIMENTS

The present invention is directed to an apparatus which can be used to clean one or more surfaces (e.g., two opposing surfaces or a single surface) and associated methods. In one embodiment, the surface or surfaces are the lenses of a pair of eye glasses, a computer screen or cell phone screen, or any other surface. Each component of the apparatus and method of use are hereafter described in more detail.

A. Surface Wiper

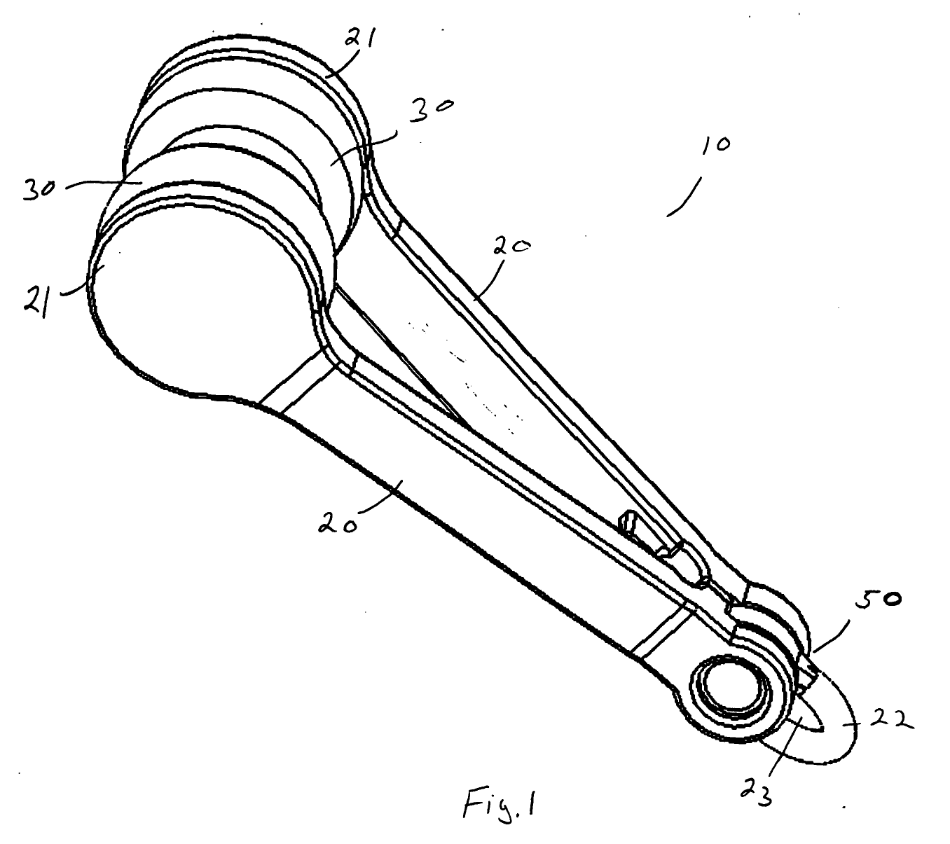

With reference to FIGS. 1, 2, 3, and 4, the figures show one embodiment of a surface wiper. In one embodiment, the present invention includes a pair of tongs 20 and two wiping components 30, for example in an opposing configuration. In certain embodiments, tongs 20 are connected or joined in a V- or U-shape configuration. In one embodiment, open ends of tongs 20 include heads 2 1, which can be round, cylindrical, square, spherical or other regular or irregular shapes. The primary function of tongs 20 is to allow a consumer to hold the present invention with his or her fingers and bias heads 21 away from each other.

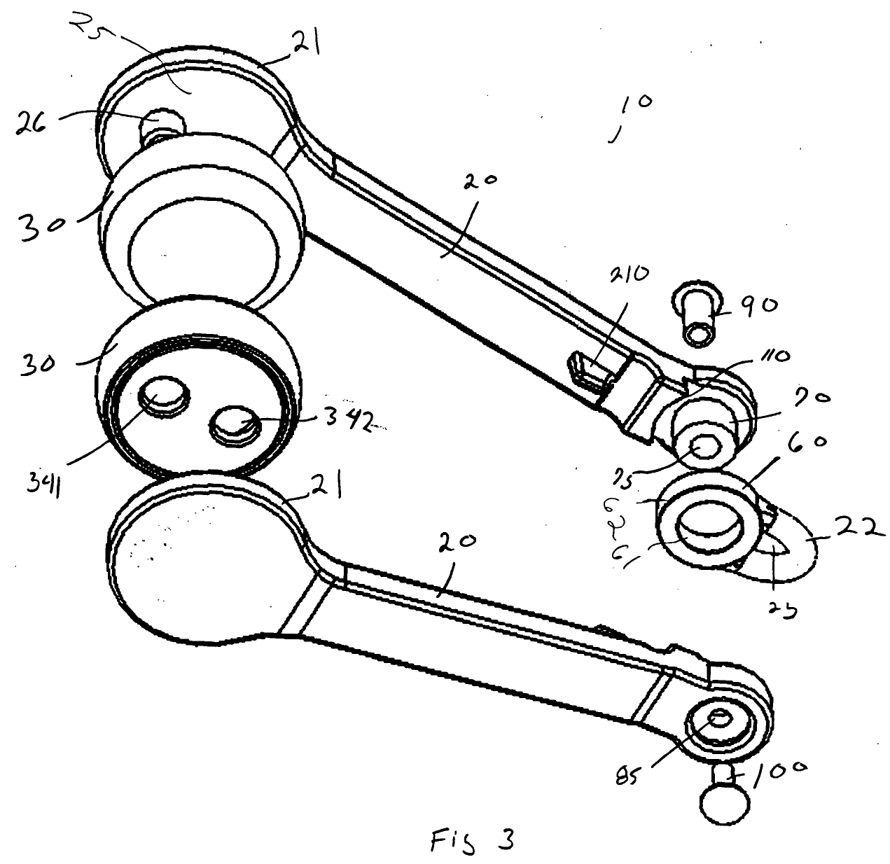

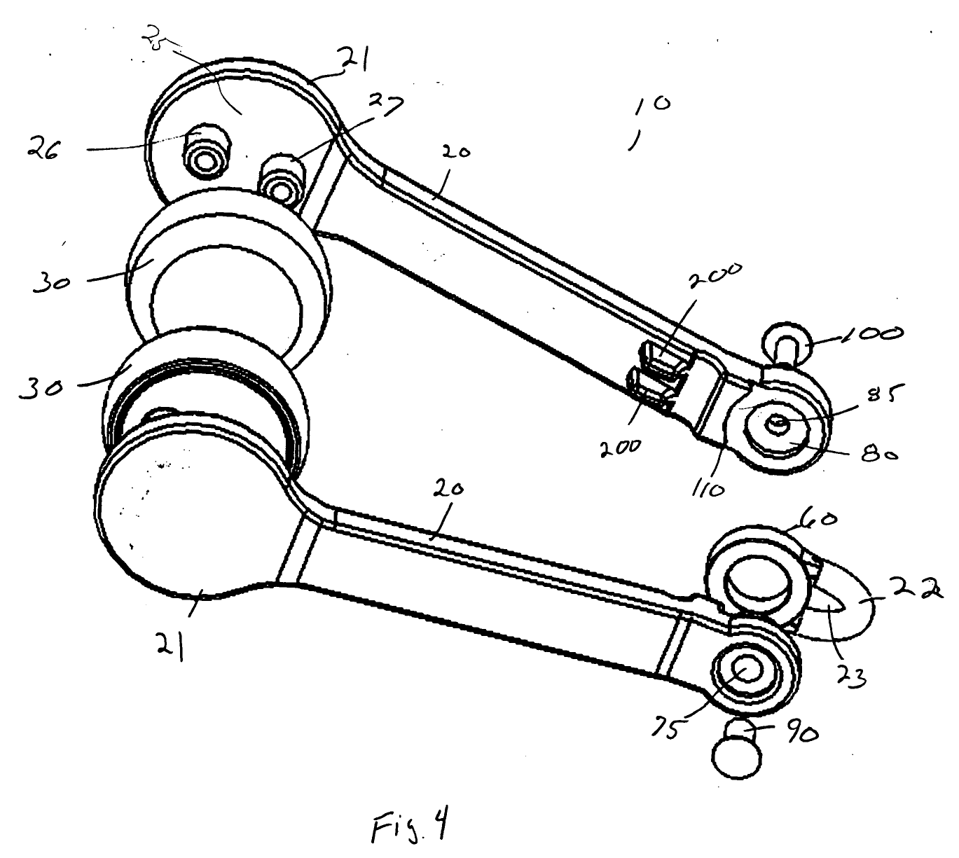

As shown in FIGS. 3 and 4, head 21 has at least one post 26 located thereon. In one embodiment, the present invention includes at least one, more typically two or more, posts 26 and/or 27 positioned along a certain line of head 2 1. In another embodiment, one or more posts 26 of the present invention are located on inner side 25 of head 2 1. In certain embodiments, posts 26 and/or 27 can be any regular or irregular shape. In one embodiment, posts 26 and/or 27 are cylindrical in shape. In one embodiment, posts 26 and/or 27 includes flanges at or near the tip of post 26 (e.g., the head of post 26) to snap fit or secure ring 24 thereto, as described in more detail below. In another embodiment, post 26 and/or 27 is bulbous at or near the tip, and the bulbous portion can be used to secure wiping components 30 to head 21 of tongs 20, as described in more detail below.

B. Joining of Tongs

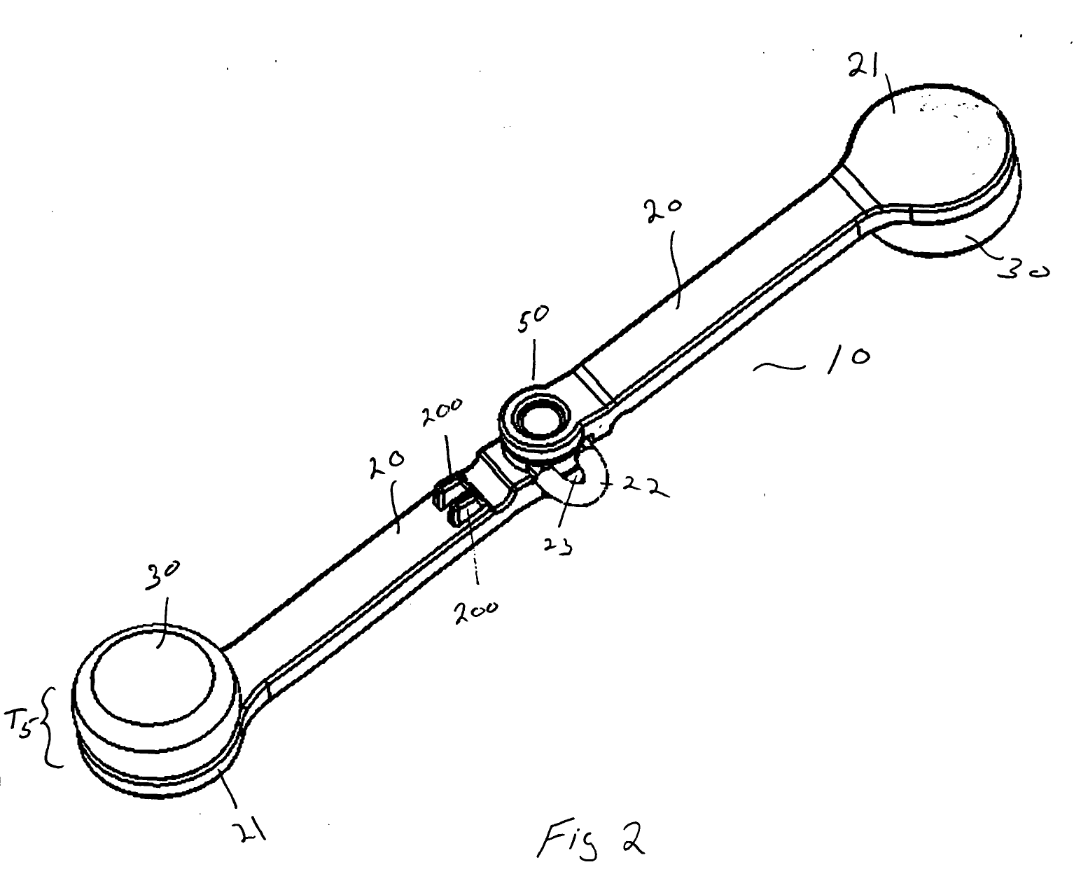

In one embodiment, shown by FIGS. 1 and 2, tongs 20 are joined by a swivel 50, which permits tongs 20 to rotate about an axis defined by the swivel. In certain embodiments, swivel 50 permits the separation of tongs 20 from each other by between 1 to 180 degrees (as shown in FIG. 2).

As shown in FIGS. 3 and 4, swivel 50 includes ring 60. A first tong 20 includes ring post 70 which is inserted into ring 60 and typically includes an opening or hole 75 for receiving peg 90. The other tong 20 includes ring post seat 80 which is adapted to secure ring post 70 and also includes hole 85 for insertion peg 100. Ring 60 is then secured between both tongs 20, thereby forming a swivel, by inserting insertion peg I 00 into receiving peg 90, which forms the axle for the swiveling of tongs 20 about ring 60. In certain embodiments insertion peg 100 snap or pressure fits into receiving peg 90. In another embodiment, pegs 90 and 100 can be secured together by friction or an adhesive or a weld, taking care to be certain that ring 60 and tongs 20 can continue to rotate about the axle formed by pegs 90 and I 00. Another configuration for a swivel which may be suitable for certain embodiments of the present invention is shown in U.S. Pat. No. D475,166, the content of which is hereby incorporated by reference.

Both tongs 20 can be adapted to rotably secure ring 60 to the present invention. In certain embodiments, tongs 20 include rounded surface 110 thereby permitting the tongs to rotate about the swivel while also securing ring 60 between post 70 and rounded surface 110.

In certain embodiments, tongs 20 are joined at a bending point such as the joining configurations shown and described in, e.g., U.S. Pat. Nos. 5,547,842, 6,339,860, and 4,480,352, the entire contents of which are hereby incorporated by reference. Tongs 20 can be made from any material, including plastic, wood, metal, and combinations thereof. In one embodiment, tongs 20 are joined at a bending point and it is desirable to manufacture at least a portion of tongs 20 from an easily bendable material (e.g., metal and/or plastic) to reduce the stress on the bending point which occurs while the device is in use. In other embodiments, tongs 20 are rigid or semi-rigid.

C. Loop

In certain embodiments, the pair of tongs 20 is extended by a loop 22 with a through hole 23. In certain embodiments, a second ring such as a key ring or a solid ring is attached via through hole 23. The second ring enables a consumer to attach the present invention to a fastener (such as a ring fastener or a carabiner) and then to a strap of a handbag or the belt loop of a pair of pants. In certain embodiments, loop 22 can be connected to a key loop to provide convenience to the consumer.

In certain embodiments, loop 22 is attached to ring 60, as shown in FIGS. 1, 2, 3, and 4. However, loop 22 can be located anywhere on the body of present invention, including on tongs 20 (e.g., at or near seat 80 and/or post 70 and/or head 21).

D. Wiping Components

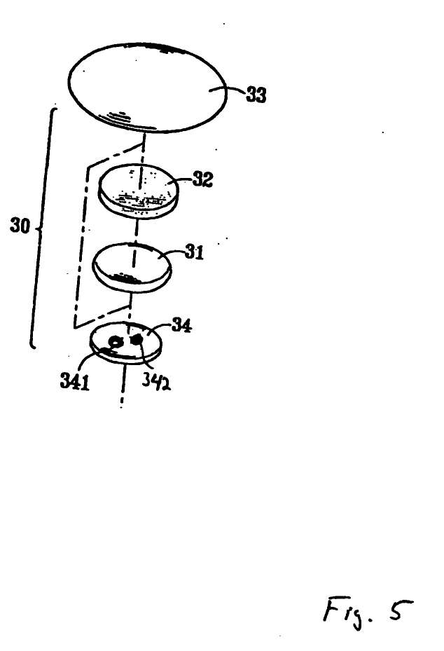

The present invention includes at least one, preferably two or more wiping components. In certain embodiments, each wiping component 30 includes a layer structure similar to that shown and described in U.S. Pat. No. 5,457,842. In particular, as shown in FIG. 5, in one embodiment wiping component 30 includes a shell seat 31, a soft pad 32, a piece of wiping cloth 33 and a fixed disc 34.

In one embodiment, shell seat 31 is a disc and in certain embodiments has an overall shape similar to a bottle cap such that fixed disc 34 can fit therein. The present invention also includes a soft pad 32 (for example, sponge, cotton, felt and other soft materials). Soft pad 32 is wrapped by a piece of wiping cloth 33 (which is chosen to be compatible with the surface to be wiped). In certain embodiments, wiping cloth 33 is linen, non-woven linen or cotton paper, micro-fiber material, etc, and combinations thereof. In one embodiment, the excessive edges of wiping cloth 33 are tucked into the space of the bottom of the shell seat 31. A fixed disc 34 is then put in the space of shell seat 31, thereby securing wiping cloth 33.

In one embodiment, the center of fixed disc 34 includes one or more openings 341 and/or 342, which permit the insertion of posts 26 and/or 27 on head 21 of tong 20 to thereby connect wiping component 30 to head 21 of tong 20. Post or posts 26 and/or 27 are tucked into an inner wall of the openings 341 and/or 342, thereby forming, in certain embodiments, a friction fit. The fit enables wiping component 30 to touch a surface to be cleaned and carry out the wiping function without detaching from head 21 and tong 20. In another embodiment, wiping component 30 can be secured to tongs 20 by an acceptable mechanical connection or an adhesive.

It should be noted that although wiping component 30 is typically a rounded shape, it can be any regular or irregular shape. In certain embodiments, it is desirous to include a protrusion and/or relatively thin edge on wiping component 30 (typically by altering the shape of the materials which are used to make wiping component 30) to facilitate the wiping of a surface, e.g., an area of a pair of eye glasses closest to the nose pieces of the glasses.

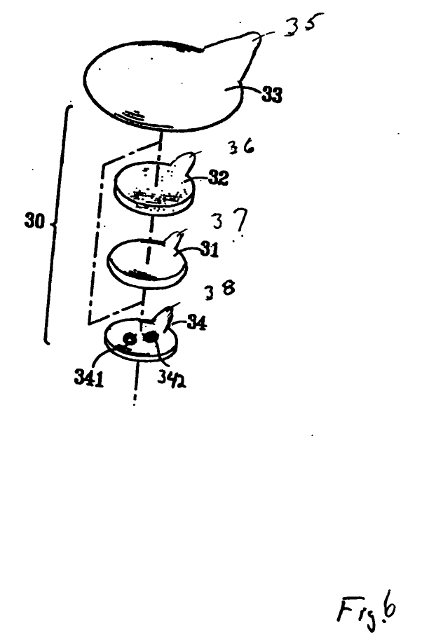

In one embodiment, for example as shown in FIG. 6, a protrusion 35 on wiping component 30 is shown. Specifically, one or more of the components which make up wiping component 30 can have one or more protrusions 35, 36, 37 and/or 38 to facilitate the cleaning of a surface having structure that prevents wiping of all or a portion of a surface, for example to facilitate in cleaning along side or under a nose piece of a pair of eye glasses.

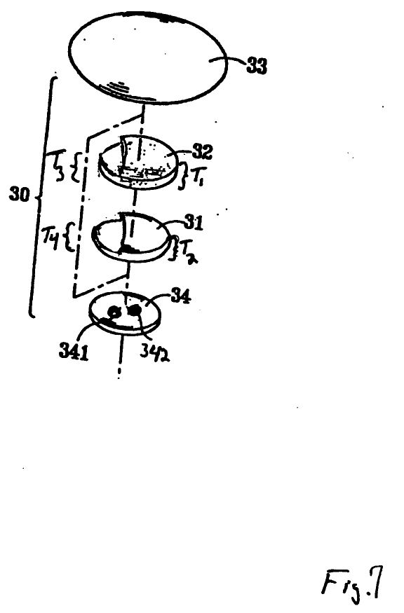

In another embodiment, and with respect to FIG. 7, any or all of the components which make up wiping component 30 can have variable thicknesses, thereby forming a portion of wiping component 30 having a thinner edge relative to the remainder of the wiping component. As shown in FIG. 7, soft pad 32 and shell seat 31 can have at least two distinct thicknesses. In particular thickness T3 is less than thickness T1 and thickness T4 is less than thickness T2. In certain embodiments, T3 and T4 are the same thickness. In another embodiment, T3 and T4 are different thicknesses. In certain embodiments, T3 and T4 have a thickness of about 0.01 cm to 1 cm, more typically about 0.01 mm to 0.25 mm. Once combined, the reduced thickness can create a thin edge on wiping component 30 to facilitate the cleaning of an area of a pair of glasses.

Similarly, as shown in FIG. 2, wiping component 30 can have a total overall thickness T5 between about 0.02 cm to 1 cm or more, more typically about 0.20 cm to 1 cm or more.

In some embodiments, it should be noted that shell seat 31 has an overall bottle-cap like configuration and is hollow underneath to permit the insertion of fixed disc 34. Accordingly, the actual material thickness of shell seat 31 can be relatively thin. However, the perceived thickness (i.e., the thickness of the shell seat 31 when viewed edgewise, and not the actual material thickness) is important in certain embodiments so that fixed disc 34 can fit into the space formed by shell seat 31 and secure assembled wiping component 30 to head 21.

E. Swivel Lock

In certain embodiments, the present invention also includes a swivel lock which prevents unwanted free rotation of tongs 20 about an axel formed by insertion peg 100 into receiving peg 90. The swivel lock can be used to keep wiping components 30 of each tong 20 in close proximity to each other, as shown in FIG. 1. In another embodiment, a swivel lock of the present invention can be used to lock wiping components 30 in a position that is between 1 and 180 degrees of separation (e.g., 180 degrees of separation is shown in FIG. 2) between wiping components.

As shown in FIGS. 2, 3, and 4, the swivel lock of the present invention can include one or more raised surfaces 200 on a first tong and one or more raised surfaces 210 on a second tong. With respect to a raised surface swivel lock, it is desirable to include at least two raises surfaces on at least one tong 20 to prevent unwanted free rotation of the tongs. Raises surfaces 200 and 210 can be any regular or irregular shape, including circular, square, tetrahedral or other polyhedral shape.

The raised surfaces of each tong can then be forced together to mesh such that a raised surface of one tong fits between raised surfaces of the other tong, thereby preventing, reducing or hindering unwanted free rotation. Raised surfaces 200 and 210 are typically made from the same material as tongs 20. However, raised surfaces 200 and/or 210 can be made from the same or different material as tongs 20.

It should be noted that the degree of meshing of the raised surfaces, and thereby the difficulty of locking or unlocking the swivel lock, can vary and can be controlled by changing the shape of raised surfaces 200 and/or 210 and/or by adjusting the positioning of the raised surfaces on tongs 20. The degree of meshing typically depends upon the flexibility of the material used in forming tongs 20 and/or raised surfaces 200 and 210. If the materials are highly flexible, the degree of meshing can be high because the flexibility of the material allows for easy separation of the meshed raised surfaces without increased risk of fracture of the raised surface(s). If the flexibility of the material is relatively low, the degree of meshing should also be reduced. Accordingly, in certain embodiments only a portion of raised surface 200 meshes with raised surface 210. In certain embodiments, only 5, 10, 25, 33, 50, 66 or 75 percent of the total surface area of a raised surface 200 of a first tong contacts a raised surface 210 of the other tong. In one such embodiment, raised surfaces 200 and 210 are generally the same shape or different shapes. In another embodiment, raised surface 210 is a raised “U” shape and raised surface 200 fits between the straight portions of the “U” shaped raised surface 210.

In another embodiment of the invention, a first tong 20 includes one or more raised surfaces 210. Raised surface 210 can be any shape including cubic, pyramidal, hemispherical, spherical, or other convex regular or irregular shape. Second tong 20 includes one or more concave indentations or dimples which are adapted to receive raised surface 210. By receiving raised surface 210 into the dimple or dimples, unwanted free rotation of tongs 20 can be prevented. By controlling the depth of the dimple, a user can more easily control the free rotation of tongs 20. In one embodiment,

In another embodiment, and in particular an embodiment wherein tongs 20 are made from a flexible material, the swivel lock can be a snap or pressure fit which can be engaged by forcing tongs 20 together, and released by pulling tongs 20 apart.

In another embodiment, swivel 50 includes a compression swivel lock. In certain embodiments, the components of swivel 50 locks tongs 20 in a position separated by between 1 and 180 degrees by compressing all or a portion of tongs 20 together. Specifically, the friction between the tongs 20 about swivel 50 can be adjusted by loosening or tightening together pegs 90 and 100. In one embodiment, pegs 90 and 100 are manually tightened or loosened.

In another embodiment, swivel 50 includes a ring 60 which further includes a bezel or ratchet type swivel lock that allows a user to move tongs 20 relative to each other and to be locked in any desired position. In certain embodiments, ring 60 further includes teeth on one or more surface 61 and/or 62. The teeth can mesh with other teeth on either one or both of post 70 or surface 110. Accordingly, in such an embodiment, tongs 20 can be separated by between 1 to 180 degrees and tongs 20 lock or “click” into place as the teeth mesh together. In such an embodiment, swivel 50 can act like a bezel or ratchet wherein each degree, two (2) degrees, or five (5) degrees of separation are represented by a separate locking ratchet position.

The subjoined claims therefore are intended to be construed to cover not only those embodiments of this invention disclosed above but also to cover all such embodiments, variants and equivalents of the invention as may be made by those skilled in the art to which the invention pertains, which embodiments, variant and equivalents are within the true spirit and scope of this invention. Any of the above described embodiments or element may be combined with other embodiments or elements of the invention. Additionally, each and every reference cited above is hereby incorporated by reference.

What is claimed is:

1. A wiper comprising:
a first and second tong, wherein each tong comprises a head on a free end of the tong and wherein the tongs are connected by a swivel;
a wiping component that is connected to the head of a tong; and
a swivel lock, wherein the swivel lock is configured to prevent free rotation of the tongs about the swivel when the swivel lock is engaged.

2. The wiper of claim 1, wherein the wiping component each comprises a shell seat, a soft pad, a piece of wiping cloth, and a fixed disc with at least one opening.

3. The wiper of claim 2, wherein the wiping cloth is wrapped around a soft pad and secured to a shell seat.

4. The wiper as claimed in claim 1, wherein the tongs are U-shaped.

5. The wiper as claimed in claim 1, wherein the tongs are V-shaped.

6. The wiper as claimed in claim 1, wherein the heads are circular.

7. The wiper of claim 1, wherein the swivel lock comprises at least one raised surface on a first tong.

8. The wiper of claim 7, wherein the swivel lock further comprises at least one raised surface on a second tong.

9. The wiper of claim 7, wherein the swivel lock further comprises at least one dimple on a second tong.

10. The wiper of claim 1, wherein the swivel lock comprises a compression swivel lock.

11. The wiper of claim 1, wherein the swivel lock comprises a ratchet swivel lock.
